(19) United States
(12) Patent Application Publication
(10) Pub. No.: US 2023/0375988 A1
(43) Pub. Date: Nov. 23, 2023

(54) SYSTEM AND METHOD FOR IRRIGATION MANAGEMENT USING MACHINE LEARNING WORKFLOWS

(71) Applicant: Valmont Industries, Inc., Omaha, NE (US)

(72) Inventors: John A. Kastl, Wahoo, NE (US); Jacob L. LaRue, Owasso, OK (US); Andrew Carritt, Fremont, NE (US); Joshua M. Dixon, Elkhorn, NE (US)

(73) Assignee: Valmont Industries, Inc., Omaha, NE (US)

(21) Appl. No.: 18/351,008

(22) Filed: Jul. 12, 2023

Related U.S. Application Data
(63) Continuation-in-part of application No. 17/865,858, filed on Jul. 15, 2022.
Application No. 17/865,858 is a continuation of application No. 15/994,260, filed on May 31, 2018, now Pat. No. 11,429,071.
(60) Provisional application No. 62/513,479, filed on Jun. 1, 2017.

(51) Int. Cl. G05B 13/04; A01G 25/16; A01G 25/09; G05B 13/02

(52) U.S. Cl. CPC G05B 13/041; A01G 25/16; A01G 25/092; G05B 13/0265

(57) ABSTRACT

The present invention provides a system and method which includes a machine learning module which analyzes data collected from one or more sources such as UAVs, satellites, span mounted crop sensors, direct soil sensors and climate sensors. According to a further preferred embodiment, the machine learning module preferably creates sets of field objects from within a given field and uses the received data to create a predictive model for each defined field object based on detected characteristics from each field object within the field.

### RELATED APPLICATIONS

The present application is a Continuation-In-Part of U.S. patent application Ser. No. 17/865,858 filed Jul. 15, 2022; which is a Continuation of U.S. patent application Ser. No. 15/994,260 filed May 31, 2018; which claims priority to U.S. Provisional Application No. 62/513,479 filed Jun. 1, 2017.

### BACKGROUND AND FIELD OF THE PRESENT INVENTION

### Field of the Present Invention

The present invention relates generally to a system and method for irrigation system management and, more particularly, to a system and method for using machine learning to model and design workflows for an irrigation system.

### Background of the Invention

The ability to monitor and control the amount of water, chemicals and/or nutrients (applicants) applied to an agricultural field has increased the amount of farmable acres in the world and increases the likelihood of a profitable crop yield. Known irrigation systems typically include a control device with a user interface allowing the operator to monitor and control one or more functions or operations of the irrigation system. Through the use of the user interface, operators can control and monitor numerous aspects of the irrigation system and the growing environment. Further, operators can receive significant environmental and growth data from local and remote sensors.

Despite the significant amounts of data and control available to operators, present systems do not allow operators to model or otherwise use most of the data or control elements at their disposal. Instead, operators are limited to using intuition and snapshots of available data streams to make adjustments to their irrigation systems. Accordingly, despite the large amounts of data created, the decision-making process for growers has not significantly changed in several decades.

Outside the field of irrigation, a number of machine learning methods have been developed which enable supervised and unsupervised learning models based on defined sets of data. For example, support vector machines (SVMs) allow for a supervised learning model which uses associated learning algorithms that analyze data used for classification and regression analysis. Accordingly, an SVM training algorithm is able to build a model using, for instance, a linear classifier to generate an SVM model. When SVM and other types of models can be created, they may be used as predictive tools to govern future decision making.

In order to overcome the limitations of the prior art, a system is needed which is able to collect and integrate data from a variety of sources. Further, a system and method is needed which is able to use the collected data to model, predict and control irrigation and other outcomes in the field.

### SUMMARY OF THE PRESENT INVENTION

To address the shortcomings presented in the prior art, the present invention provides a system and method which includes a machine learning module which analyzes data collected from one or more sources such as historical applications by the irrigation machine, UAVs, satellites, span mounted crop sensors, field-based sensors and climate sensors. According to a further preferred embodiment, the machine learning module preferably creates sets of field objects (management zones) from within a given field and uses the received data to create a predictive model for each defined field object based on characteristic data for each field object within the field.

The accompanying drawings, which are incorporated in and constitute part of the specification, illustrate various embodiments of the present invention and together with the description, serve to explain the principles of the present invention.

### BRIEF DESCRIPTION OF THE DRAWINGS

FIG. 1 shows an exemplary irrigation system for use with the present invention.

FIG. 2 shows a block diagram illustrating the exemplary processing architecture of a control device in according with a first preferred embodiment of the present invention.

FIG. 3 shows an exemplary irrigation system with a number of exemplary powered elements are included in accordance with further preferred embodiment of the present invention.

FIG. 4A shows a block diagram illustrating a preferred method in accordance with a preferred embodiment of the present invention.

FIG. 4B shows a block diagram illustrating a further preferred method in accordance with a preferred embodiment of the present invention.

FIGS. 5A-5C show diagrams illustrating examples of field object definitions in accordance with a preferred embodiment of the present invention.

FIG. 6 shows a block diagram illustrating further aspects of an exemplary method and system of the present invention.

FIG. 7 shows an exemplary algorithm for processing electrical current and voltage data in accordance with a preferred embodiment of the present invention.

FIG. 8 shows an exemplary algorithm for processing water pressure data in accordance with a preferred embodiment of the present invention.

FIG. 9 shows an exemplary algorithm for processing water pressure data and flow rate data in accordance with a preferred embodiment of the present invention.

FIG. 10 shows an exemplary algorithm for further processing of water pressure data and flow rate data in accordance with a preferred embodiment of the present invention.

FIG. 11 shows an exemplary algorithm for processing accelerometer and gyroscopic data in accordance with a preferred embodiment of the present invention.

FIG. 12 shows an exemplary algorithm for processing imaging data in accordance with a preferred embodiment of the present invention.

FIG. 13 shows an exemplary algorithm for analyzing machine fault and machine alignment data in accordance with a preferred embodiment of the present invention.

FIG. 14 shows an exemplary algorithm for managing signal transmission quality in accordance with a preferred embodiment of the present invention.

FIG. 15 shows an exemplary drone housing in accordance with a preferred embodiment of the present invention.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended and such alterations and further modifications in the illustrated devices are contemplated as would normally occur to one skilled in the art.

Where the specification describes advantages of an embodiment or limitations of other prior art, the applicant does not intend to disclaim or disavow any potential embodiments covered by the appended claims unless the applicant specifically states that it is “hereby disclaiming or disavowing” potential claim scope. Moreover, the terms “embodiments of the invention”, “embodiments” or “invention” do not require that all embodiments of the invention include the discussed feature, advantage, or mode of operation, nor that it does not incorporate aspects of the prior art which are sub-optimal or disadvantageous.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Additionally, any examples or illustrations given herein are not to be regarded in any way as restrictions on, limits to, or express definitions of, any term or terms with which they are utilized. Instead, these examples or illustrations are to be regarded as illustrative only.

As used herein, the singular forms “a”, “an” and “the” are intended to include the plural forms as well, unless the context clearly indicates otherwise. Additionally, the word “may” is used in a permissive sense (i.e., meaning “having the potential to′), rather than the mandatory sense (i.e., meaning “must”). Further, it should also be understood that throughout this disclosure, unless logically required to be otherwise, where a process or method is shown or described, the steps of the method may be performed in any order (i.e., repetitively, iteratively or simultaneously) and selected steps may be omitted. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many of the embodiments described herein are described in terms of sequences of actions to be performed by, for example, elements of a controller. Furthermore, the sequence of actions described herein can be embodied in a combination of hardware and software including systems and methods implemented as functionality programmed into any of a variety of circuitry, including: programmable logic controllers (PLCs), programmable logic devices (PLDs), field programmable gate arrays (FPGAs), programmable array logic (PAL) devices, electrically programmable logic and memory devices and standard cell-based devices, as well as application specific integrated circuits (ASICs).

Some other possibilities for implementing aspects of the systems and methods includes: microcontrollers with memory, embedded microprocessors, firmware, software and the like. Additionally, the functions of the disclosed embodiments may be implemented on one computer or shared/distributed among two or more computers in or across a single or multiple networks or clouds. Communications between computers implementing embodiments can be accomplished using any electronic, optical, or radio frequency signals, transmitted via power line carrier, cellular, digital radio, or other suitable methods and tools of communication in compliance with known network protocols. Thus, the various aspects of the present invention may be embodied in a number of different forms, all of which have been contemplated to be within the scope of the claimed subject matter.

Additionally, any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

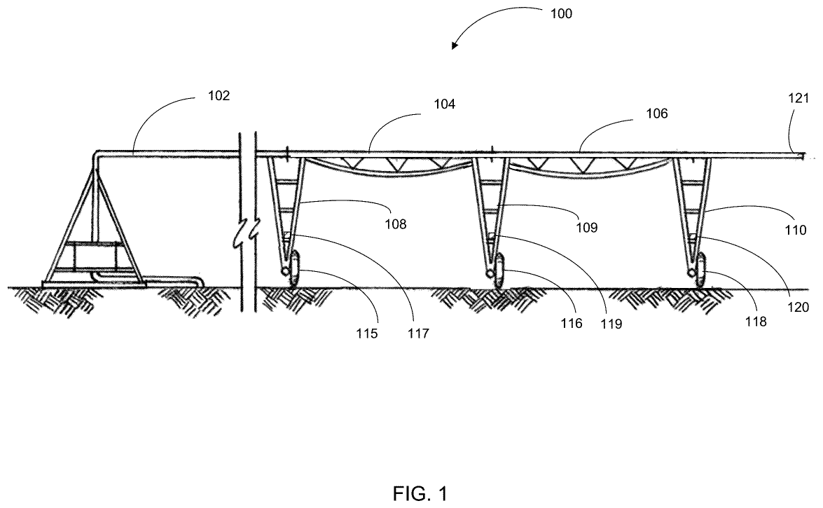

FIGS. 1-15 illustrate various embodiments of irrigation systems which may be used with example implementations of the present invention. As should be understood, the irrigation systems shown in FIGS. 1-15 are exemplary systems onto which the features of the present invention may be integrated. Accordingly, FIGS. 1-15 are intended to be purely illustrative and any of a variety of systems (i.e., fixed systems as well as linear and center pivot self-propelled irrigation systems; stationary systems; corner systems) may be used with the present invention without limitation. For example, although FIG. 1 is shown as a center pivot irrigation system, the exemplary irrigation system 100 of the present invention may also be implemented as a linear irrigation system. The example irrigation system 100 is not intended to limit or define the scope of the present invention in any way. According to further preferred embodiments, the present invention may be used with a variety of motor types such as gas powered, DC powered, switch reluctance, single phase AC and the like. Still further, the exemplary embodiments of the present invention are primarily discussed with respect to direct spray irrigation methods. However, the methods and systems of the present invention may be used with any methods of delivering applicants without limitation. For example, further delivery methods used by the present invention may include methods such as drip, traveling gun, solid set, flood and other irrigation methods without limitation.

With reference now to FIG. 1, spans 102, 104, 106 are shown supported by drive towers 108, 109, 110. Further, each drive tower 108, 109, 110 is shown with respective motors 117, 119, 120 which provide torque to the drive wheels 115, 116, 118. As further shown in FIG. 1, the irrigation machine 100 may preferably further include an extension/overhang 121 which may include an end gun (not shown).

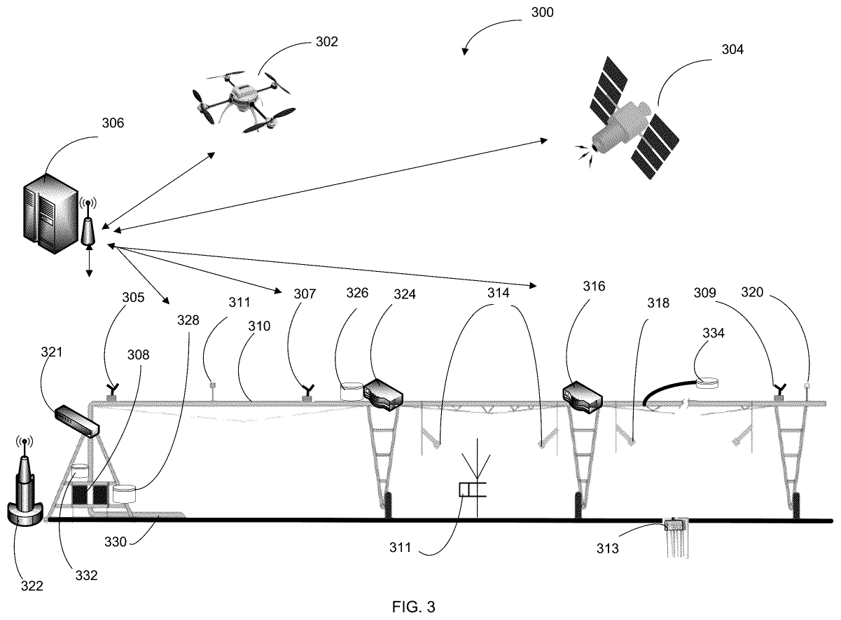

As shown, FIG. 1 provides an illustration of an irrigation machine 100 without any added powered elements and sensors. With reference now to FIG. 3, an exemplary system 300 is shown in which a number of exemplary powered elements are included. As shown in FIG. 3, the present invention is preferably implemented by attaching elements of the present invention to one or more spans 310 of an irrigation system which is connected to a water or well source 330. As further shown, the exemplary irrigation system further preferably includes transducers 326, 328, as well as drive units 316, 324 which are preferably programed to monitor and control portions of the irrigation unit drive system.

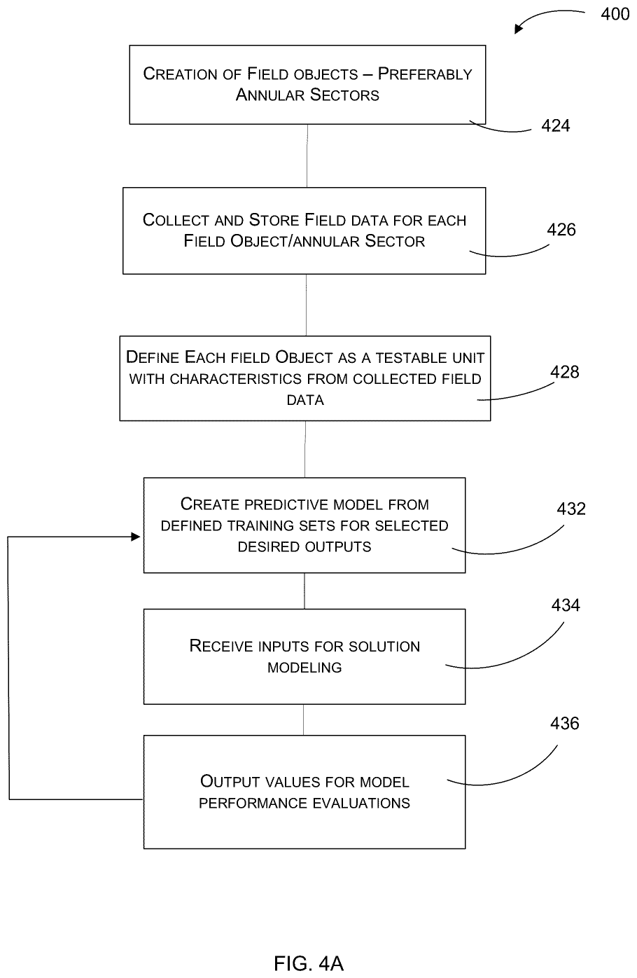

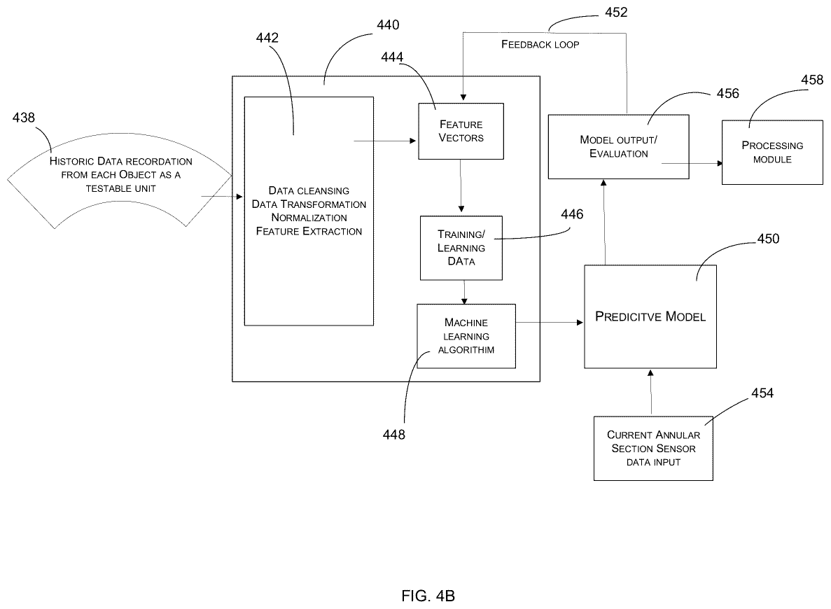

Further, the system of the present invention preferably further includes elements such as a GPS receiver 320 for receiving positional data and a flow meter 332 for monitoring water flow in the system. Further, the system of the present invention preferably includes a range of sensors and may receive a range of sensor data from a variety of sources as discussed further herein. As discussed with respect to FIG. 4A below, these sensors and inputs include any number of onboard sensors, in situ sensors, remote/offsite sensors, and land survey data as well as manufacturer/grower and/or specialist-provided measurements or specifications.

With reference again to FIG. 3, representative indirect crop sensors 314, 318 are shown which may collect a range of data (as discussed below) including soil moisture levels. Additionally, the sensors 314, 318 may further include optics to allow for the detection of crop type, stage of grown, health, presence of disease, rate of growth and the like. Additionally, the system may preferably further include one or more direct sensors 311 which may be directly attached to a plant to provide direct readings of plant health and status. Additionally, one or more direct soil sensors 313 may also be used to generate soil moisture, nutrient content or other soil-related data. For example, preferred soil sensors 313 may record data related to a variety of soil properties including: soil texture, salinity, organic matter levels, nitrate levels, soil pH, and clay levels.

The detection system may further include a climate station 322 or the like which is able to measure weather features such as humidity, barometric pressure, precipitation, temperature, incoming solar radiation, wind speed and the like. The system may also include a wireless transceiver/router 311 and/or power line carrier-based communication systems (not shown) for receiving and transmitting signals between system elements.

Additionally, the system may include integrated suites of sensors 334 for monitoring aspects of the climate, ground and crop status. For example, the suite of sensors 334 may include a precipitation detector 403 which preferably may detect forms and rates of precipitation. The exemplary integrated sensor suite element 334 of the present invention may preferably include an accelerometer which may detect the tilt, orientation and acceleration of the sensor suite element 334. Still further, the sensor suite element 334 may further include a GPS chip or the like. Additionally, the sensor suite element 334 of the present invention may include a radiometer to determine the long wave and short wave incoming solar radiation and photosynthetically active radiation. Additionally, the sensor suite element 334 may include a spectrometer such as a seven-band spectrometer or the like. Additionally, the exemplary sensor suite element 334 may include internal communications chips and a solar panel to separately power the sensor suite 334 or any other sensors discussed herein.

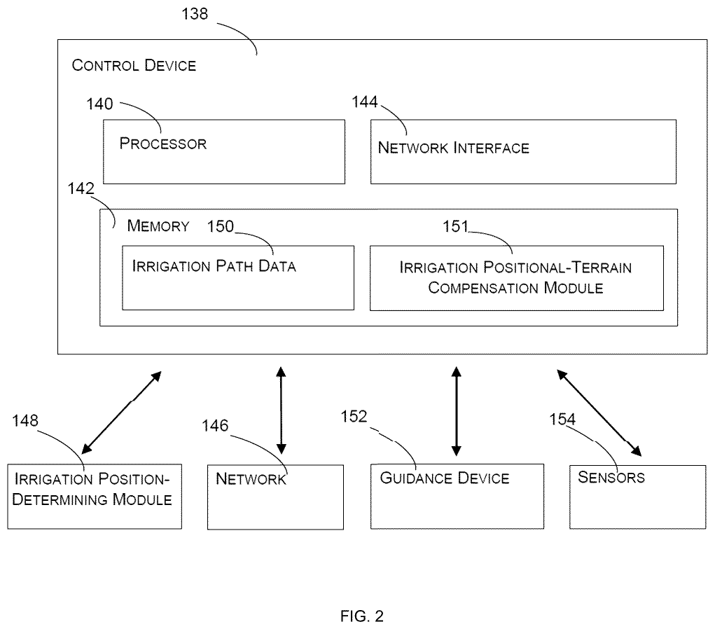

With reference now to FIG. 2, an exemplary control device 138 which represents functionality to control one or more operational aspects of the irrigation system 100 will now be discussed. As shown, the exemplary control device 138 includes a processor 140, a memory 142, and a network interface 144. The processor 140 provides processing functionality for the control device 138 and may include any number of processors, micro-controllers, or other processing systems. The processor 140 may execute one or more software programs that implement techniques described herein. The memory 142 is an example of tangible computer-readable media that provides storage functionality to store various data associated with the operation of the control device 138 such as a software program and code segments mentioned above, or other data to instruct the processor 140 and other elements of the control device 138 to perform the steps described herein. The network interface 144 provides functionality to enable the control device 138 to communicate with one or more networks 146 through a variety of components such as wireless access points, transceivers power line carrier interfaces and so forth, and any associated software employed by these components (e.g., drivers, configuration software, and so on).

In implementations, the irrigation position-determining module 148 may include a global positioning system (GPS) receiver, a LORAN system or the like to calculate a location of the irrigation system 100. Further, the control device 138 may be coupled to a guidance device or similar system 152 of the irrigation system 100 (e.g., steering assembly or steering mechanism) to control movement of the irrigation system 100. As shown, the control device 138 may further include a positional-terrain compensation module 151 to assist in controlling the movement and locational awareness of the system. Further, the control device 138 may preferably further include multiple inputs and outputs to receive data from sensors 154 and monitoring devices as discussed further below.

With further reference to FIG. 3, according to a further preferred embodiment, the system of the present invention may further include distributed data collection and routing hubs 305, 307, 309 which may directly transmit and receive data from the various span sensors to a machine learning module 306 provided on a remote server 306 which receives a number of inputs from the sensors of the irrigation system 300. In this embodiment, the machine learning module 306 preferably includes service-side software which may be accessed via the internet or other network architecture. Alternatively, the machine learning module 306 and other aspects of the present invention may include client-side software residing in the main control panel 308 or at another site. Regardless, it should be understood that the system may be formed from any suitable combination of software, hardware, networked and/or remote elements configured to implement the features of the present invention.

According to a further preferred embodiment, the systems of the present invention preferably operate together to collect and analyze data. According to one aspect of the present invention, the data is preferably collected from one or more sources including imaging and moisture sensing data from UAVs 302, satellites 304, span mounted crop sensors 318, 314, as well as the climate station 322, in-ground sensors 313, crop sensors 311, as well as data provided by the control/monitoring systems of the irrigation machine 100 itself (e.g. as-applied amount, location and time of application of irrigation water or other applicant, current status and position of irrigation machine, machine faults, machine pipeline pressures, etc.) and other system elements. Preferably, the combination and analysis of data is continually processed and updated.

According to further preferred embodiments, the control/monitoring systems of the irrigation machine 100 may include oil sensors units within each drive unit. These oil sensor units may preferably feedback regarding oil quality, usage and whether the drive unit needs an oil change. Additionally, the oil sensor units may monitor oil levels/pressures and monitor for oil leaks, oil viscosity and low/high oil levels. According to a preferred embodiment, the analysis systems of the present may preferably analyze data produced by the control/monitoring systems of the irrigation machine to determine and select system responses. For example, the analysis system may preferably receive machine operational data (e.g. fluid levels, temperatures, viscosities) and analyze this data using data from other machine sensors. According a preferred embodiment, the analysis system may preferably change a measuring threshold range for analyzing data from one or more additional monitored data sources (i.e. oil sensors, water sensors, engine sensors). For example, the analysis system may receive data indicating the ambient temperature of an irrigation machine. The analysis system may preferably use the environment data to adjust a parameter used by the analysis system for monitoring oil level, type or quality. For example, the analysis system may adjust acceptable limits for oil viscosity based on ambient temperatures. In another example, the analysis system may adjust thresholds for determining acceptable water pressure levels based detected wind speeds. Still further, the analysis may lower engine speeds based on detected temperature levels or changes in gradient. This analysis may preferably be performed and adjusted using data from any system as discussed further herein.

According to further preferred embodiments, data may further be collected from UAVs/drones which may be linked to and/or tethered to the irrigation system. According to a first preferred embodiment, such linked UAV/drones may alternatively be housed within a drone housing 321 which may preferably provide a protected space for landing and storing a linked drone. The drone housing 321 of the present invention may preferably function as a docking station for both power and data transfer between linked/active drones and the control systems of the irrigation machine. Alternatively, a linked drone may be tethered with an attached cable allowing for data and power transfer. The system of the present invention preferably further allows for transmitting data wirelessly in flight. Power may be transferred during flight via a directed energy source such as laser, microwave or the like. In such embodiments, the precise location and orientation of the drone would preferably be transmitted from the drone. According to further preferred embodiments, drones of the present invention may be programmed to function autonomously with pre-defined geofenced areas/volumes (i.e., directional and altitudinal boundaries within a given airspace). Such geofenced areas/volumes would preferably allow sorties/operations of the drone to be conducted by a Beyond Line Of Site (BLOS) drone operators and/or automated pre-defined flight paths.

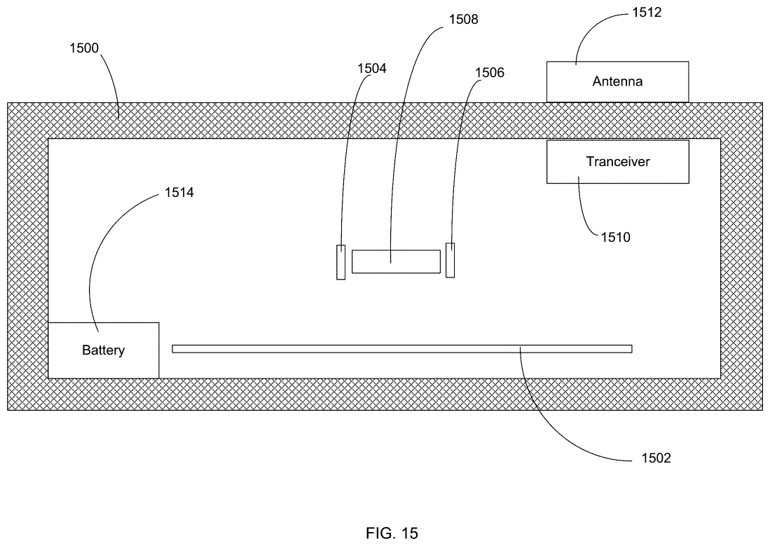

With reference now to FIG. 15, the exemplary drone housing(s) 1500 of the present invention may preferably be located anywhere on the irrigation equipment. According to preferred embodiments, the drone housing 1500 may preferably be located at the pivot point or end tower of a center pivot irrigation span. Alternatively, the housing may be located at the cart or end tower of a linear machine. In the case of a pivot with a corner arm, the last regular drive unit (LRDU) would be the preferred location. The drone housing 1500 of the present invention may include a drone platform 1502 and an optical sensor 1508 or the like to provide location and positioning data to a drone. The drone housing 1500 may preferably include charging elements 1504, 1506 for contact or wireless charging. Wireless charging may alternatively be provided via the landing platform 1502.

The power/charging elements 1504, 1506 of the drone housing 1500 may preferably be linked directly or indirectly to the electrical system of the irrigation machine. Preferably, the powering/charging of the drone via the drone housing may further include a battery 1514 or similar device to provide power when the power is not available on the irrigation machine. Preferably, energy storage may be accomplished via a lithium-ion battery, a lead-acid battery or the [symbol] . Further, power/charging elements 1504, 1506 of the drone housing 1500 and the drone may include attached solar panels which may recharge batteries.

The drone housing may preferably further include a transceiver 1510 for providing wireless data transfer between the drone and the drone housing 1500. The drone housing 1500 may preferably collect and store data for retransmission to the machine controller or other remote element. The data may further be transmitted to the cloud for further processing via radio, cellular or satellite data links. Alternatively, the data connection preferably may be connected/integrated into the existing mechanized irrigation data transmission system (e.g., radio, cellular, satellite) typically located at the linear cart or pivot point. According to alternative embodiments, the data transmission of the present invention may be accomplished by any approach, including power line carrier, fiber, dedicated wire, wireless, etc. using any known protocol such as TCP/IP, Ethernet, and the like.

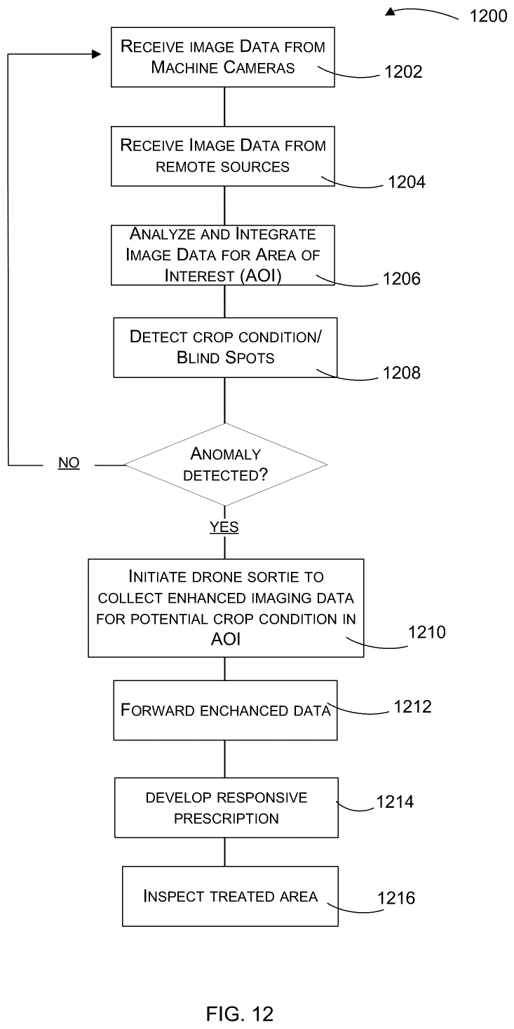

According to further preferred embodiments, a drone for use with the present invention may preferably be programmed to interface with the control system of the present invention to perform scouting and mapping of a given field in support of other data collection systems of the irrigation machine. Referring now to FIG. 12, an exemplary method of the present invention may include a first step 1202 of receiving imaging data from sensors/imaging devices mounted on or near the irrigation machine. At a next step 1204, the system may further receive data from remote sources which may include satellite imaging and the like. At a next step 1206, the system of the present invention may preferably analyze the imaging data and determine anomalies in a monitored area indicating an issue such as pests, diseases, nutrient stress, water stress, lack of emergence, lagging or leading crop development, etc. in an area of the field. At a next step 1208, the system may then determine where blind spots exist and/or where higher resolution imaging would benefit analyzing a detected anomaly. At a next step 1210, where such an area/anomaly is detected, the system of the present invention may initiate a drone sortie to scan the area with a higher resolution or specialized sensor (e.g., camera, thermal imager, spectrometer, etc.) to cover areas not covered by the sensors on the irrigation structure so as to fully map the area of interest. At a next step 1212, the enhanced data may then be forwarded to the operator and/or main system to notify the operator of the area of concern. At a next step 1214, the enhanced data may then be used to analyze and develop prescriptions to selectively apply remediation to the identified area.

According to preferred embodiments, such remediation can include application of crop protection products (e.g., fungicides, herbicides, pesticides, biologics), nutrients (e.g., nitrogen, potassium, phosphorous, etc.), water (e.g., variable rate irrigation), physical destruction using lasers, flame, or similar. The remediations may be applied by the irrigation machine (VRI, chemigation, fertigation), drone, spray rig, aerial application, irrigation machine-mounted sprayer/system, mechanical cultivation, or tractor-mounted systems. According to a preferred embodiment, the development and application of prescriptions/remediation steps may be performed autonomously by the system and/or drone. Furthermore, after remediation, at a next step 1216 the irrigation machine mounted sensors and/or the drone can be commanded to inspect the treated area to verify the completeness and/or effectiveness of the remediation.

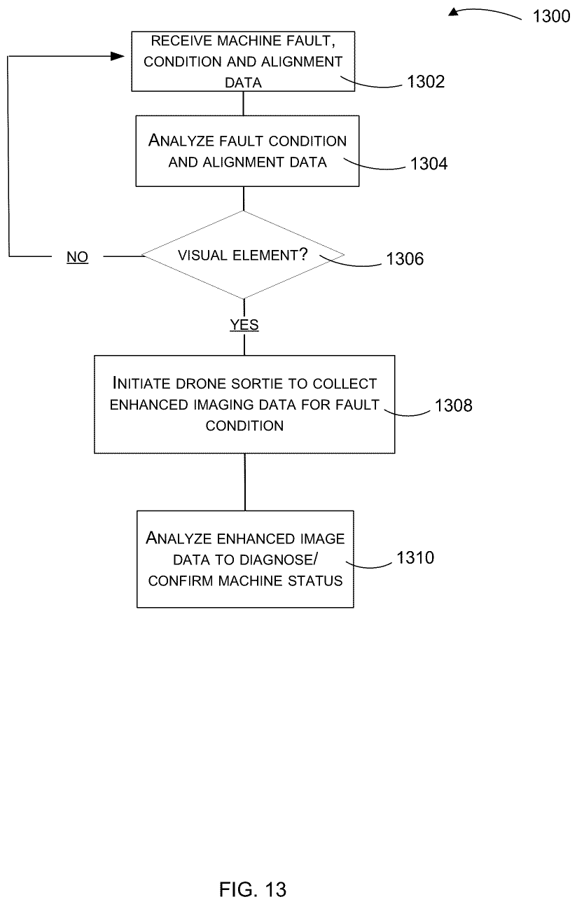

According to further preferred embodiments, the drone of the present invention may preferably be programmed to interface with the control system of the present invention to perform machine inspections. Referring now to FIG. 13, an exemplary method of the present invention may include a first step 1302 of receiving machine fault, condition and/or alignment data. At a next step 1304, the system may analyze the fault condition and/or alignment data. At a next step 1306, the system may determine/look-up whether a suspect fault/condition has a pre-determined visually detectable element. At a next step 1308, the system may initiate a drone sortie to collect enhanced imaging data for the visually detectable elements of a given fault/condition. Alternatively, the drone may be automatically dispatched to regularly inspect the irrigation machine for visually detectable elements indicating a variety of faults/ [symbol] ditions. Further, the operator could dispatch the drone via the system control panel or via the machine's remote monitoring and control system.

Whether pre-scheduled or initiated in response to a detected condition, the drone may perform sorties to inspect the irrigation machine for a variety of faults, including, but not limited to machine alignment, low tire pressure, broken or plugged sprinklers, position of the linear cart on the path, position of the corner arm relative to the guidance path, and/or damage to drive units or the drivetrain. The fault/conditions may include safety issues such as a safety fault in the safety circuit, low tire pressure, high motor current, low or high water pressure during irrigation, overwatering timer safety and the like. Further, the drone may be prompted to inspect the status of drive wheels/tracks if a stuck drive unit is indicated by the machine diagnostics system. Other applications may include monitoring of water depth and mobile dam overflow on linears utilizing rolling inlets with moveable dams or the like. Still further, the drone may also monitor the linear cart location on the cart path, alignment of the machine relative to field boundaries and crop rows, indicators on the engine, pump, liquid levels (fuel, crop protection and crop nutrition product tanks) either at a given pre-set schedule or in response to detected conditions.

At a next step 1310, the system may analyze enhanced/targeted image data to diagnose/confirm machine status. According to preferred embodiments, the system may send identified images to the operator for review and diagnosis of the problem prior to sending a repair or maintenance crew into the field for repairs. Alternatively, AI/ML image recognition systems may be used on the drone or pivot controller to automatically confirm a diagnosis. Preferably, the image data may be analyzed in combination with the machine diagnostic data from machine-based sensors (e.g., tire pressure, water pressure, motor current, alignment sensors, etc.) to further identify suspected conditions. Further, the imaging data may be used by an operator or AI/ML system (e.g., in combination with location data or the like) to decide whether to continue irrigating, stop the machine where it is, or to stop irrigating and move a given machine to an area in a given field which is more accessible for repairs/maintenance.

Similarly, the drone and control systems of the present invention may initiate drone sorties in response to detected security issues. Such security issues may include: the detected field entry by unknown personnel or sensing of damage to the irrigation machine (e.g., theft of span cable, unscheduled power use, unexpected water pressure, pump or engine start, unusual vibrations of the structure, etc.). Further, security issues may include detected damage to field fencing or other equipment in the field. In response to a detected security issue (or pre-schedule security sweep), the drone of the present invention may fly a pre-determined path to image the irrigation machine to identify the cause and/or to capture images of the perpetrators and damage found. According to further preferred embodiments, the drone in a detected security situation may be directed to land in a secure location and to send a notification signal to the operator indicating drone position for later recovery of the drone and data captured by the drone. According to further preferred embodiments, the system of the present invention may also be used after extreme weather events as indicated by in-field weather sensors, machine accelerometers, and/or weather data from the National Weather Service or similar weather data providers.

According to further preferred embodiments, the drone system of the present invention may preferably be programmed to coordinate with the transceiver elements of the irrigation system to repeat, store and/or forward communication signals to and from an irrigation machine when it experiences intermittent or poor connectivity. In these cases, the drone of the present invention may preferably be launched or re-tasked to provide a data link between a given backhaul endpoint and the irrigation equipment. Further, the drone of the present invention may be commanded to move to a pre-determined location and establish connections with both the backhaul node and the irrigation equipment to facilitate connections/data transfer. Alternatively, the drone may be programmed to self-determine an optimum location for communications by maximizing the signal strength from both the backhaul endpoint and the irrigation equipment using any known search algorithm. Furthermore, the drone may actively shift positions to maintain signal strength during Tx/Rx operations.

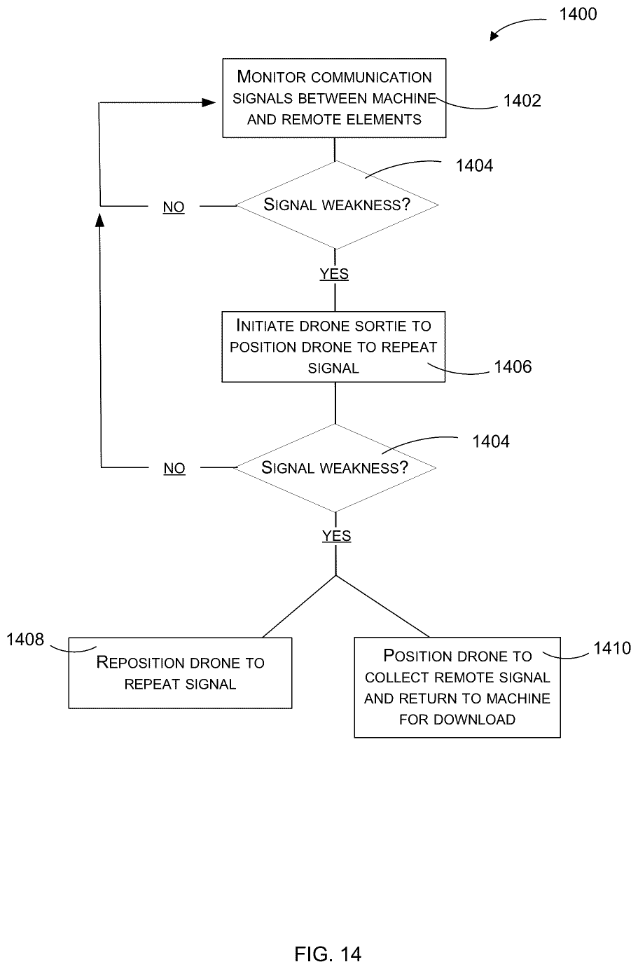

Referring now to FIG. 14, an exemplary method of the present invention may include a first step 1402 of monitoring communication signals between the irrigation machine transceiver elements. Preferably, such signal monitoring may include one or more transmission protocols including for instance: Wi-Fi, 3G, 4G, CDMA, TDMA, OSM, Ethernet, Bluetooth, Zigbee, MIMO and/or any other standards based or proprietary protocols capable of transmitting data. At a next step 1404, the drone and/or irrigation machine elements may determine low or weak signal strength within a given transmission protocol. At a next step 1406, the system may initiate a drone sortie to position the drone to repeat signals to and from the irrigation system and to act as a range extender to supplement identified weak signals. At a next step 1408, the system may reposition the drone to repeat identified signals. At a next or alternative step 1410, the system may further position the drone to collect remote signals and then return to a position nearer to the irrigation machine for a download of collected data. According to preferred embodiments, in executing step 1410, the drone may be dispatched regularly on a pre-planned flight path to hover over and collect data from sensors in the field such as soil moisture probes, nitrogen probes, weather sensors and the like.

To collect data, the drone may be programmed to hover and/or land in the area of each sensor, collect the data wirelessly and then return to the irrigation machine and forward the data to the cloud or irrigation machine for further [symbol] ysis. Alternatively, the drone may preferably directly send the data wirelessly to the cloud, the irrigation or both. In response, various prescriptions may be adjusted. For example, data collected from soil moisture probes may cause the system to adjust the VRI prescription based on the collected [symbol] . Still further, the system of the present invention may include a fleet of drones located on the machine that preferably may be programmed to conduct sorties in groups ahead of an operating machine using sensor arrays to measure field conditions (e.g., crop temperature, moisture, health) and sending data back to the analysis system (e.g., control panel on the pivot) wirelessly where the geolocated data would be processed. For example, the drone sorties may image and identify data the system may analyze to determine a modified crop water stress index which would then be used to modify a parameter of the application by the machine. In response, the system may adjust the amount of water applied (i.e., variable-rate irrigation) as the machine passes over the areas identified from drone acquired data. Still further, the drone may image and collect data for use in calculating and adjusting dynamic variable nutrient or crop protectant applications (e.g., VR chemigation or VR Fertigation).

Other types of data collected may include data from livestock located in a given field (e.g., such as ear-tag sensor data, activity and/or movement patterns of animals in a given area). Such data may be analyzed using AI/ML and used for inventory tracking such as correlating ear-tag and movement data to specific animals. Further, the drone image analysis may identify visual and/or thermal evidence of disease indicators (e.g., raised temperatures for livestock, excess mucus, low movement activity, disease signs in [symbol] ). Other uses for drones may preferably include irrigation, monitoring, chemical application of areas not covered by the irrigation equipment. For example, corners of the field on pivots.

With reference now to FIGS. 3-11, a preferred method for use of the machine learning module 306 of the present invention will now be discussed. It should be understood that this method of analysis is exemplary, and many other methods may be used without limitation. In particular, the systems and methods of the present invention may function without using field objects or other management zone techniques. As discussed further below, the system may operate independent of these techniques as it receives and reacts to data.

Additionally, in preparation for processing, combining, and evaluating the data collected from the sensor sources as discussed below, the machine learning module 306 will preferably first receive field measurements and dimensions. According to a preferred embodiment, the field dimensions may be input from manual or third-party surveys, from the length of the physical machine or from image recognition systems utilizing historical satellite imagery. Alternatively, the data hubs 305, 307, 309 may preferably further include survey sensors such as GPS, visual and/or laser measurement detectors to determine field dimensions.

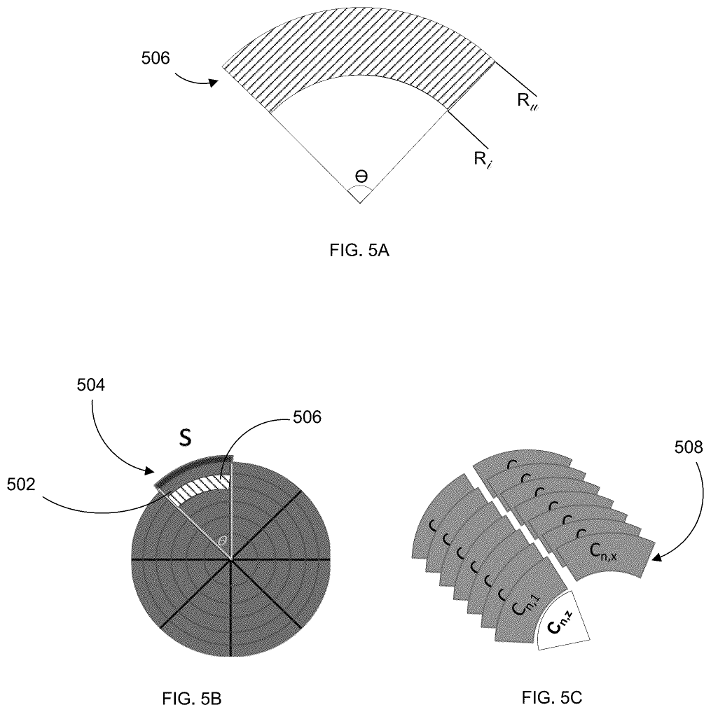

With reference now to FIG. 4A, following the input of the field measurements and dimensions, the machine learning module 306 at step 424 will then preferably create subsections of the entire field and store the created subsections as field objects known as “management zones”. As shown in FIG. 5A, according to a preferred embodiment, for a center pivot irrigation machine, the created field objects are preferably created as annular sectors 506 formed as subsections of rings defined by an inner and outer circle of arbitrary radii. These radii may be consistently incremented or variably incremented depending on a variety of factors, including but not limited to the spacing of sprinklers along the machine, varying banked groups of sprinklers or other factors. Circumferentially, the rings are sub-sectioned into annular sectors by radii defined by an angle (Θ).

As show in FIG. 5B, the angle (Θ) is preferably defined by an arc length 504 which may be an arbitrary length supplied by the user, the throw radius of the last sprinkler, defined by the resolution of the locational awareness system of the irrigation machine or other factor. Further this arc length need not be consistent from segment to segment within the field area. However, all arc lengths must sum to the circumference of the circle from which they have been sub-sectioned and they may not overlap one another. Similarly, the angles (Θ) must sum to 360 and the locations of these angles (Θ) must be such that the areas encompassed by each angle do not overlap and are always adjacent to other angles (Θ). As shown in FIG. 5C, the field objects 508 may preferably each be broken down into data sets consisting of columns C₁ to Cₙ where each C is defined as a collection of annular sectors (labeled C_{n,1}, C_{n,2}, . . . C_{n,x}) and one circular sector (labeled C_{n,z}) that fall under an arbitrary arc length (s). Still further, as shown in FIGS. 5A-C, each annular sector may preferably be defined as having:

$$Area = \frac{π \times Θ}{360} {( {R}_{u} - {R}_{i} )}^{2}$$

where Θ is the angle formed by adjacent radii separated by the outer circumference length S; Rᵤ is the radius of the outer arc; and Rᵢ is the radius of the inner arc of the annular segment. According to alternative preferred embodiments, the field objects may alternatively be evaluated or assessed on a grid system, polar coordinate system, or use any other spatial categorization system as needed.

With reference again to FIG. 4A, at step 426, data for each defined field object is preferably collected and stored as discussed above. Accordingly, the characteristic data may include data from any of the sensor discussed herein. These may, for example, include:
Onboard sensory arrays—Including both active and passive systems that describe or measure characteristics of the target locale and/or equipment. Such sensor measurements may include measurements of: direct soil moisture or plant status; crop canopy temperature; ambient air temperature; relative humidity; barometric pressure; long and short-wave radiation; photosynthetically active radiation; rainfall; wind speed; and/or various spectral bands off of the soil and crop canopy. Further, measured sensor data may include data from the irrigation machine control/monitoring systems including: GPS position; pivot/linear systems data; pressure from along the pipeline; status of sprinklers; flow rate (GPM/LPS); valve position; on/off times; pattern dimensions/diameter; voltage; error messages; percent timer setting; direction, forward or reverse; fertigation/chemigation status; water chemistry information; and other operational information.
Offsite remote sensory—Including aerial, UAV (as discussed above) and satellite data or other data acquired from systems not affixed to the target locale or equipment. Such data may include: Geo-tiff images, spectral data including RGB bands, NIR, IR (Thermal), weather-focused radar, radar-based terrain, active and passive microwave imagery for soil moisture and crop growth, and derived indices, such as NDVI, based on these and other individual spectral bands. Further, such data may include evapotranspiration data from satellite heat balance models including infrared heat signatures and data from a crop stress index model. Further, remote data may include climate data from climate stations sufficient to compute or estimate evapotranspiration such as temperature, relative humidity, precipitation, solar radiation, wind speed, rain, weather data and projected conditions. Further, data may include feedback from crop peak ET as well as soil mapping data.
In situ sensory—May include information such as: soil and buffer pH; macronutrient levels (nitrogen, phosphorus, potassium); soil organic matter (carbon) content; soil texture (clay content); soil moisture and temperature; cation exchange capacity (CEC); soil compaction; depth of any root restricting layers; soil structure and bulk density.
Land survey data—Including descriptive, numeric and graphic data from public and/or private sources including geographic, geologic and any other physical or physically-derived measure of target locale; field characteristics; soils/EC/CRNP data; topography; field shape; and data from publicly available soil maps and databases.
Manufacturer's specifications of irrigation system—Pivot characteristics; span configuration; flowrate; maximum allowable inches/acre; required pressure; maximum speed; sprinkler package, endgun or not.
Grower and/or specialist-provided measurements or specifications—Including but not limited to: soil analysis, soil or water chemistry, geographic analysis, meteorological analysis, irrigation or nutrient schedules or historical operational; yield data; soil water balance calculations; soil moisture in the root zone; soil moisture by depth; soil moisture forecast in root zone; soil moisture forecast by depth; crop species/variety/type; planting date; emergence date; replanting date; critical soil moisture allowable depletion; published crop coefficient curves; privately developed crop coefficient curves; on-premises sensor based determinations of crop growth stage; evapotranspiration calculation data; whole field uniform evapotranspiration estimates; parts of the field evapotranspiration estimates; and whole field variable evapotranspiration estimates.

With reference again to FIG. 4A, at step 428, each field object/annular sector is preferably defined as a discrete data point containing characteristics inherited from field-level data as well as characteristics derived from its relationship to other data points (e.g., neighboring soil types and elevations). In one embodiment, as an example, slopes from adjacent field objects may be utilized to calculate the runoff of excessive rainfall into or out of a specific field object.

At step 432, the created discrete data points are preferably used by the machine learning module 306 to create a predictive module for each discrete data point. According to a preferred embodiment, the machine learning module 306 performs the modeling function by pairing each data point with input/output data for the field object and evaluating the data over time or as a non-temporal set. According to a further preferred embodiment, the performance timelines/observations are then evaluated for a particular output, as part of the entire collection, with the evaluating machine learning how to categorize data points and building an algorithm that accurately reflects the observed performance timelines for the desired output. One or more of these algorithms are then preferably assembled into a solution model which may be used to evaluate new fields in real time for the purpose of assisting growers in optimizing profitability, cash flow, regulatory compliance, water, fertilizer or chemical application efficiency, or any other measurable or intangible benefit as may be required or discovered.

According to a preferred embodiment, the solution model may preferably be created for each management zone (i.e. one or more field objects, annular sectors and/or other irrigable units) of each field. Further, the solution models may preferably be created whole or in part by any number or combination of human-provided heuristics and/or machine-created algorithms. Further, the algorithms may be created by regressions, simulations or any other form of machine/deep learning techniques. According to further preferred embodiments, the solution model of the present invention may be delivered as neural networks, stand-alone algorithms or any combination of learned or crafted code modules or stand-alone programs. Further, the solution model may preferably incorporate live/cached data feeds from local and remote sources.

With further reference now to FIG. 4A, the solution model of the present invention may preferably be delivered to a grower via a push/pull request from content delivery network, point-to-point connection or any other form of electronic or analog conveyance. Further, the system will preferably allow an operator to accept, reject or modify a solution model after review.

Once a model is delivered, at step 434, data inputs are preferably received and provided to the model for evaluation. At step 436, output values are generated as discussed further below. Preferably, the data inputs preferably include acceptance, rejection or modifications of the solution model from the operator and any updated data from any of the list of data inputs discussed above with respect to steps 424-432. Further, the data inputs may include additional data such as grower specified and/or desired data such as: desired direction of travel; base water application depth; variable rate prescription for speed, zone or individual sprinkler; grower chemigation recommendation; chemigation material; chemigation material amount ready for injection; base chemigation application amount per unit area; variable rate prescription for speed, zone or individual sprinkler; irrigation system and/or sensor operational or repair status.

With reference now to FIGS. 4A and 4B, an example method for inputting data and outputting modeled values shall now be further discussed. As shown in FIG. 4B, the machine learning module 440 of the present invention may preferably be used to receive historical data 438 (step 428 in FIG. 4A) which may include data recorded over a period of time (i.e. weeks, months, years) for each object within a given field. This historic data is preferably received by the machine learning module 440 and used to create predictive models 450 from defined training sets 446 for selected desired outputs (step 432 in FIG. 4A). To create the predictive models 450, the machine learning module 440 preferably further includes submodules to process the received data 442 including steps such as data cleansing, data transformation, normalization and feature extraction.

Once extracted, the target feature vectors 444 are forwarded to a training module 446 which is used to train one or more machine learning algorithms 448 to create one or more predictive models 450. In the example shown, the predictive model 450 preferably receives current sensor data input 454 (step 434 in FIG. 4A) and outputs model output/evaluation data 456 (step 436 in FIG. 4A) which is provided to a processing module 458 to create system inputs and changes based on the model output 456. At step 452, the output values 456 and current inputs 454 may preferably be fed back into the machine learning module 440 via a feedback loop 452 so that the module 440 may continually learn and update the predictive model 450.

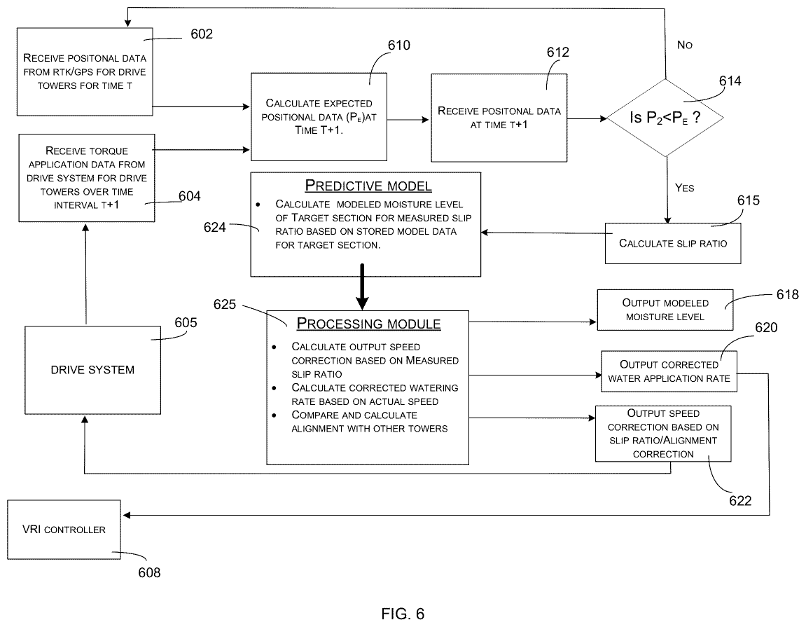

With reference now to FIG. 6, a further example application of the present invention shall now be further discussed. As shown in FIG. 6, the example application concerns the adjustment of drive and VRI systems based on detected system data. As shown, the example data fed into the system may include positional data 602 for a given time (P₁). Further, example data may include torque application data 604 from the drive system 605 (D₁) indicating the amount of torque applied to a drive wheel over a given interval of time (i.e. T+1). With these data inputs, the system of the present invention may preferably calculate the expected position (P_{E}) of the drive tower 610 after the given interval of time (i.e. T+1). Further, the system may preferably receive detected positional data 612 for the location of the drive tower after the given length of time (i.e. P₂). At a next step 614, the predicted and detected locations are compared and if P₂<P_{E}, the system at a next step 615 may further calculate a slip ratio (i.e. P₂/P_{E}) which is then forwarded to the predictive model 624 for analysis.

According to a preferred embodiment of the present invention, the exemplary predictive model 624 shown in FIG. 6 is preferably created and updated by the methods described with respect to FIGS. 4A, 4B and 5 discussed above. As shown in FIG. 6, the exemplary predictive model 624 may calculate moisture levels (i.e. ground moisture levels) from a range of calculated slip ratios. More specifically, the exemplary predictive model 624 may preferably calculate a modeled moisture level for a given annular region based on a measured slip ratio. At next step, the estimated moisture level of the given annular region may then be forwarded to a processing module 625 which then may use the estimated moisture level to make selected adjustments to the irrigation system. For example, the processing module may calculate a speed correction based on the measured slip ratio which is then outputted 622 to the drive system 605. The speed corrections may further include a comparison of speeds between towers and a calculation of alignments between towers. Further, the processing module may calculate a corrected watering rate 620 which may be outputted to the VRI controller 608. Further, the processing module 625 may output an updated moisture level 618 to be included in system notifications or other calculations.

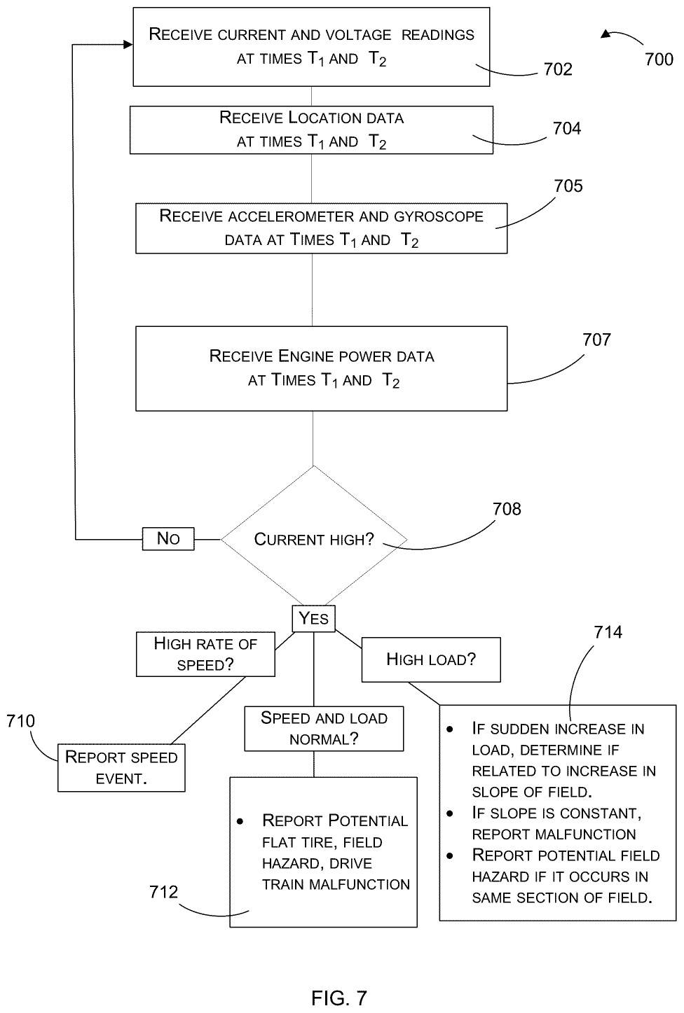

With reference now to FIGS. 7-11, the algorithms of the present invention may preferably be used to analyze a variety of data and to detect and predict problems during field operations. Further, the algorithms of the present invention may command an action or recommend an action to the appropriate personnel (e.g., operator, owner, service person, or dealer). According to another aspect of the present invention, the commands and recommendations may include instructions regarding preventative maintenance. Such notifications may also provide selectable options for an operator which may trigger actions by the irrigation machine as discussed further below.

With reference now to FIG. 7, an exemplary algorithm 700 for analyzing changes in electrical current and voltage sensor data shall now be discussed. As shown in FIG. 7, at a first step 702, current and voltage data may be recorded and stored at times T₁ and T₂. At a next step 704, location data for the irrigation machine may be recorded and stored at times T₁ and T₂. At a next step 705, accelerometer and gyroscope data may be recorded and stored at times T₁ and T₂. At a next step 707, engine power data may be recorded and stored at times T₁ and T₂.

At a next step 708, the system may preferably determine whether the measured current exceeds a prescribed level. If NO, the system may return to step 702 to receive new data. If YES, the system preferably determines if the irrigation machine has undergone a high load event. For example, in step 710, the system may analyze accelerometer and/or speedometer data to determine whether the machine traveled at a high rate of speed at the measured times. If so, a notification of the high speed event may be sent. In step 714, the system may further analyze whether a high load event has occurred based on: 1) gyroscopic data indicating high slope in the field; or 2) GPS data and field data indicating rough terrain. In step 714, if the speed and load are determined to be normal, the system at step 712 may trigger a report of a potential flat tire, a field hazard, a drive train malfunction or the like.

In accordance with further aspects, the system of the present invention may alternatively use electrical current data to determine whether a motor or gear box is going bad, or whether there is an issue with a drive unit. Further, the system may analyze recorded power consumption levels for specific areas of a given field at specific speeds. Using this stored data, the system may determine whether a given increase in electrical current represents a repair issue by comparing previous current levels at the same field locations at the same sensed speeds.

According to further aspects, the present invention includes algorithms for analyzing detected phase imbalances to predict a state or winding failure. For example, the algorithms may apply Fourier transformations to detected current waves and then compare their harmonics over time. If the harmonics fall outside of specific thresholds, the system may provide notification that there is a broken rotor winding, rotor pole or the like. The exemplary algorithms may also use the phase imbalances of any running motors to determine the location and nature of any detected power failures. For example, a phase imbalance may be analyzed to determine if a power failure indicates a blown fuse or a one-way contact failure. In another example, a determination may be based on whether a single leg is bad on the power side which preferably may indicate that there was one blown fuse on a given span or unit. The present invention may also include algorithms to compare frequencies involved in the current and voltage waveforms and to correlate the existence of certain frequencies or patterns of frequencies to known failures based on correlation with historical data.

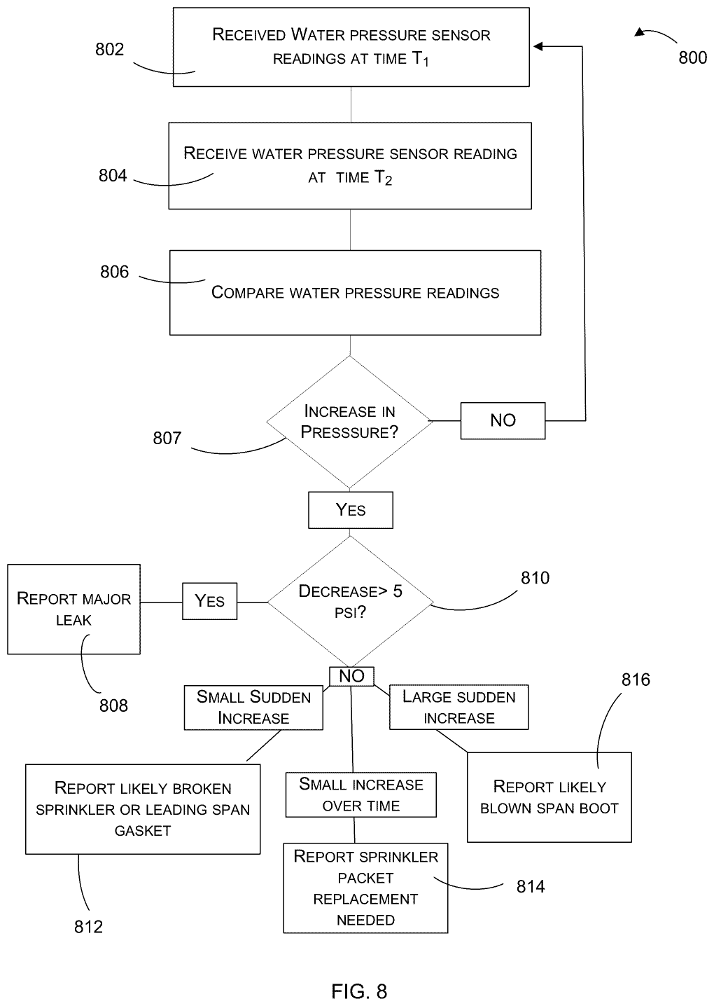

With reference now to FIG. 8, an exemplary algorithm 800 for analyzing measured water pressure rates shall now be discussed. As shown in FIG. 8, at a first step 802, water pressure sensor readings may be recorded and stored for a first time T₁. At a next step 804, water pressure sensor readings may be recorded and stored at a second time T₂. At a next step 806, the system may preferably compare the recorded water pressure data at times T₁ and T₂. At a next step 807, the system preferably determines whether any increase in water pressure has occurred. If NO, the system returns to step 802 and receives new data. If YES, the system proceeds to step 810 and determines whether the water pressure has decreased by more than 5 psi between times T₁ and T₂. If YES, the system at step 808 preferably determines that a major water leak has occurred, and the system creates a notification.

If NO, the system analyzes the data further to determine if the increase in water pressure is a 1) small, sudden increase; 2) a small increase over an extended time period; or 3) a large, sudden increase (of less than 5 psi). If the algorithm determines that the pressure increase is small and sudden, the system at step 812 may provide a notification to check for a broken sprinkler, a broken leading span gasket or the like. If the algorithm determines that the pressure increase is small and over an extended time period, the system at step 814 may provide a notification that a sprinkler package replacement may be needed. If the algorithm determines that the pressure increase is large and sudden (but under 5 psi), the system at step 816 may provide a notification to check for a blown span boot or the like.

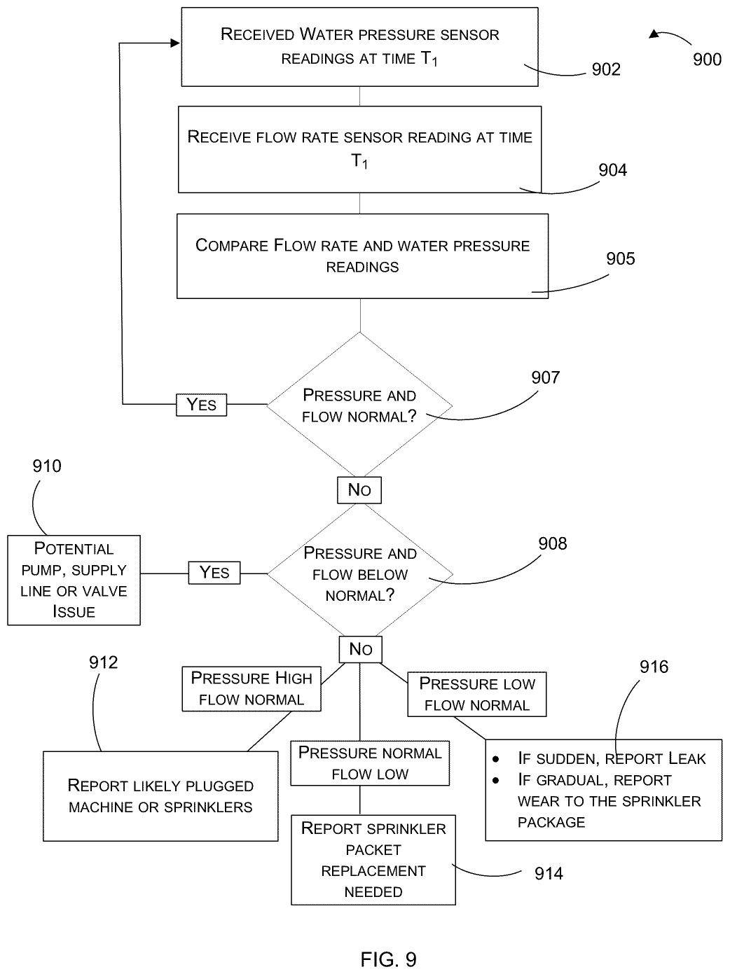

With reference now to FIG. 9 an exemplary algorithm 900 for analyzing measured water pressure rates and water flow rates shall now be discussed. As shown in FIG. 9, at a first step 902, water pressure sensor readings may be recorded and stored for a first time T₁. At a next step 904, water flow sensor readings may be recorded and stored at a time T₁. At a next step 905, the system may preferably compare the recorded water pressure and water flow data at time T₁. At a next step 907, the system may preferably determine whether both the water pressure rates and the water flow rates are within predetermined limits. If YES, the algorithm returns to step 902 and receives new data. If NO, the algorithm preferably proceeds to step 908 and determines whether both the water pressure and the water flow rates are below normal. If YES, the algorithm proceeds to step 910 and generates a notice regarding a potential water supply issue such as a malfunction at the pump, the supply line or the main supply valve.

If the system at step 908 determines NO, then the algorithm preferably compares the water pressure and flow rates to determine a likely maintenance issue. For example, if the system determines that the pressure is HIGH and the flow is NORMAL, the algorithm at step 912 preferably generates a notice that there is a likely issue with the machine or sprinkler being plugged. Alternatively, if the system determines that the pressure is NORMAL and the flow is LOW, the algorithm at step 914 preferably may generate a notice that sprinkler packet may need replacement. Still further, if the system determines that the pressure is LOW and the flow is NORMAL, the algorithm at step 916 may preferably report a potential leak (if the change is over a short period of time) or report potential wear to the sprinkler package (if the change is over a longer period of time).

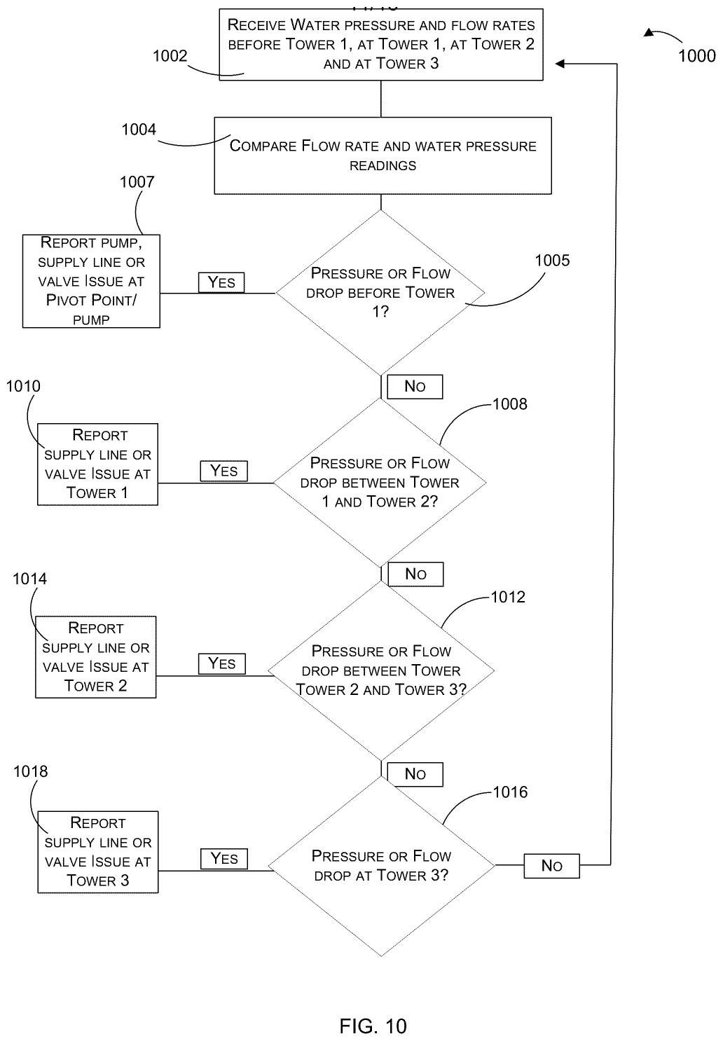

With reference now to FIG. 10, a further exemplary algorithm 1000 is shown which assists operators in locating issues in an irrigation machine. The algorithm 1000 is explained with respect to a system which includes three or more drive towers (Towers 1, 2, and 3). However, it should be understood that the location algorithm may be applied to any set of points within an irrigation system and that the exemplary drive tower points are for illustration only.

As shown in FIG. 10, at a first step 1002, the algorithm preferably first receives water pressure and flow rates before Tower 1, at Tower 1, at Tower 2 and at Tower 3. At a next step 1004, the system may preferably compare the recorded water pressure and water flow readings. At a next step 1005, the algorithm preferably determines whether the pressure or flow rates drop before Tower 1. If YES, the algorithm at step 1007 preferably prepares a notification that a pump, supply line or valve issue is likely present at the pivot point/pump.

If NO, the algorithm preferably proceeds to step 1008 and determines whether the pressure or flow rates drop between Tower 1 and Tower 2. If YES, the algorithm preferably generates at step 1010 a notice that there is a potential water supply issue at Tower 1.

If NO, the algorithm preferably proceeds to step 1012 and determines whether the pressure or flow rates drop between Tower 2 and Tower 3. If YES, the algorithm preferably generates at step 1014 a notice that there is a potential water supply issue at Tower 2.

If NO, the algorithm preferably proceeds to step 1016 and determines whether the pressure or flow rates drop at Tower 3. If YES, the algorithm preferably generates at step 1018 a notice that there is a potential water supply issue at Tower 3. If NO, the system returns again to step 1002 to receive new data.

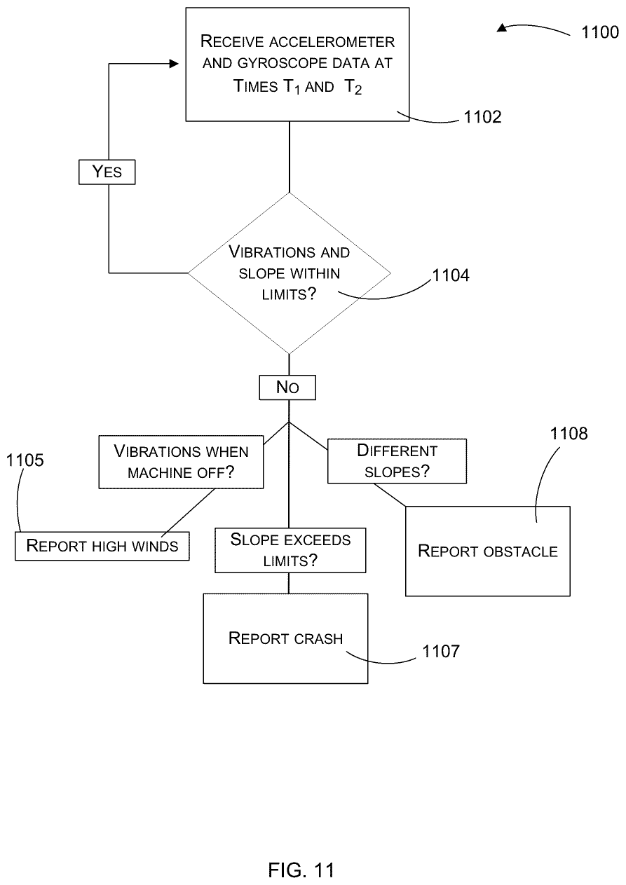

With reference now to FIG. 11, an exemplary algorithm 1100 for analyzing accelerometer and gyroscopic data shall now be discussed. As shown in FIG. 11, at a first step 1102 accelerometer and gyroscopic data may be recorded and stored at times T₁ and T₂. At a next step 1104, accelerometer and gyroscopic data is analyzed to determine if they both fall with threshold limits. If YES, the system returns to step 1102 and receives new data.

If NO, the algorithm analyzes the accelerometer and gyroscopic data against other stored data. At step 1105, the algorithm may report high winds if the system determines that the machine is vibrating when turned off. At step 1107, the algorithm may report a crash if the slope/tilt indicated by the gyroscopic sensor exceeds specific slope limits. At step 1108, the algorithm may report an obstacle if different slopes are reported from different gyroscopic sensors.

In addition to the exemplary algorithms above, the algorithms of the present invention may analyze and react to a variety of data in many other circumstances including all manner of preventative maintenance. According to a further preferred embodiment, the system of the present invention may also use data for predictive analysis (i.e. using data to model the probability of future events). This preferably may involve utilizing sensor and/or other data to predict when a part or system is likely to fail. An example may involve using the amount of load changes in a given current to determine when winding failure is likely or imminent (e.g., a punch through in the insulation). Another example of predictive maintenance may include monitoring tire pressure to determine when tire failure is likely, and the system preferably may thereafter issue commands to get the machine to a location for maintenance. Depending on detected tire pressures or leak rates, the system preferably may also issue a control command to move the machine to a service road and to notify the customer/dealer. The system preferably may also receive pressure transducer data at each tower and then adjust drive units and/or pump systems to maintain proper pressure across all towers.

In terms of voltage and current, the system may detect a high steering motor current or the like, which the system may determine indicates a likely wheel track. The system may then adjust threshold power and steering levels to prevent damage to the drive unit. For example, the system may compare where the machine is (e.g., based on guidance wire or GPS position) and make the determination to steer less severely to avoid structure damage to the drive unit. The system preferably may also measure steering angle and whether the motor is operating or not to determine if there is a broken steering gearbox or if the machine is steering in an uncommanded state.

Regarding reactive maintenance, the system may preferably include threshold levels for triggering the machine to take programmed actions. For example, the system may detect levels of tilt across an irrigation span and react by shutting down the machine to prevent it from completely tipping over. This type of reaction preferably may be used for any of a variety of detected system data. For example, the system may detect (via GPS or other motion sensors) that the machine is slowing or stopping. In response, the system may react by reducing or turning off one or more valves on the machine to reduce overwatering. The system may also react in a number of other ways including identifying a blown fuse, one-way contact failure or the like. Such a determination may preferably include shutting the machine down and transmitting a notification or alert.

Similarly, flow and pressure sensor data may be used to detect broken boots and valves. Additionally, the system of the present invention may use pressure readings from different locations on a given span to detect the location of each boot and/or valve failure.

With regard to flow sensors, if a given flow sensor detects a change for a given pressure, or the flow starts changing over time at the same pressure, or the pressure starts dropping relative to a same flow, then the system may determine that the sprinkler package or the well pump may be starting to fail or there is an issue at the well input. In response, the system may indicate an alert and may trigger machine shut down.

According to a further preferred embodiment, the system of the present invention may preferably analyze the delta P (i.e. change in pressure) across the spans. From this data, the machine may preferably determine the existence of leaking sprinkler packages, boots, and flanges. The system may also determine a location for the analytically determined leak. According to further preferred embodiments, the system of the present invention may determine the part size and type which needs replacement based on the detected location and the system may respond with a notice or order to a dealer.

It should be understood that the present invention may analyze and model a range of irrigation systems and sub-systems and provide custom models for execution based on any received data. The modeling discussed above are purely exemplary. Other modelling outputs may include instructions and/or recommendations for each sub-system including changes to: direction of travel; base water application depth; variable rate prescription for speed, zone or individual sprinkler; grower chemigation recommendation; amount and type of chemigation material; required chemigation material amount ready for injection; base chemigation application amount per unit area; center pivot maintenance and/or repair; sensor maintenance and/or repair status and the like without limitation. Where desired, each modeled output may be automatically forwarded and executed by the irrigation system or sent for grower acceptance/input in preparation for [symbol] cution.

While the above descriptions regarding the present invention contain much specificity, these should not be construed as limitations on the scope, but rather as examples. Many other variations are possible. For example, the processing elements of the present invention by the present invention may operate on a number of frequencies. Further, the communications provided with the present invention may be designed to be duplex or simplex in nature. Further, as needs require, the processes for transmitting data to and from the present invention may be designed to be push or pull in nature. Still, further, each feature of the present invention may be made to be remotely activated and accessed from distant monitoring stations. Accordingly, data may preferably be uploaded to and downloaded from the present invention as needed.

Accordingly, the scope of the present invention should be determined not by the embodiments illustrated, but by the appended claims and their legal equivalents.

We claim:

1. A system for use with a self-propelled irrigation system having at least one span and a drive system for moving the span around a given field, the system comprising:
a first plurality of drones; wherein the first plurality of drones comprises a first drone; wherein the first drone comprises a drone control module and a first drone sensor; wherein the first drone sensor is configured to produce drone sensor data; wherein the drone control module is configured to receive and store the first drone sensor data;
a drone housing; wherein the drone housing comprises a drone housing control module; wherein the drone housing is attached to the irrigation system; wherein the drone housing comprises a power charger; wherein the drone housing is configured to provide power to the first plurality of drones; wherein the drone housing control module is configured to receive the first drone sensor data from the first drone;
wherein the drone control module defines a geofenced volume around the irrigation system;
wherein the drone housing further comprises a drone housing sensor array; wherein the drone housing sensor array comprises at least one sensor selected from the group of sensors comprising: an RGB camera, a thermal camera, a temperature sensor, a humidity sensor, radar, lidar, a hyper-spectral camera and a spectrometer.

2. The system of claim 1, wherein the self-propelled irrigation system is configured to move the irrigation span around a center pivot; wherein the self-propelled irrigation system is powered by an irrigation span power system via the center pivot; wherein the drone housing is configured to receive power from the irrigation span power system.

3. The system of claim 2, wherein the system further comprises a solar panel; wherein the solar panel is mounted on the center pivot.

4. The system of claim 3, wherein the drone housing further comprises a drone housing energy storage device.

5. The system of claim 4, wherein the drone housing energy storage device comprises a rechargeable battery.

6. The system of claim 1, wherein the center pivot comprises a center pivot control module; wherein the drone housing control module is linked to the center pivot control module via a data link; wherein the data link comprises a data link type selected from the group of data link types comprising: a power line carrier, a fiberoptic cable, and a wireless data link.

7. The system of claim 1, wherein the drone housing control module is wirelessly linked to a remote analysis module.

8. The system of claim 6, wherein the drone housing control module is configured to store and forward sensor data based on available bandwidth.

9. The system of claim 7, wherein the remote analysis module is configured to analyze drone sensor data; wherein the remote analysis module is configured to identify and transmit an action recommendation based on the drone sensor data.

10. The system of claim 9, wherein the remote analysis module is configured to change an operating parameter of the irrigation machine based on the drone sensor data.

11. The system of claim 10, wherein the remote analysis module is configured to analyze a secondary data source to identify the action recommendation.

12. A method for use with the system of claim 1, wherein the method comprises:
detecting an anomaly;
developing a drone flight path based on the detected anomaly;
executing a drone flight along the drone flight path to collect anomaly data;
returning to the drone housing;
transmitting the anomaly data to a remote analysis module;
analyzing the anomaly data; and
identifying actionable recommendations for modifying the operation of the irrigation machine.

13. A method for use with the system of claim 2, wherein the method comprises:
detecting an anomaly;
developing a drone flight path based on the detected anomaly;
executing a drone flight along the drone flight path to collect anomaly data;
returning to the drone housing;
transmitting the anomaly data to a remote analysis module;
analyzing the anomaly data; and
identifying actionable recommendations for modifying the operation of the irrigation machine.

14. A method for use with the system of claim 3, wherein the method comprises:
detecting an anomaly;
developing a drone flight path based on the detected anomaly;
executing a drone flight along the drone flight path to collect anomaly data;
returning to the drone housing;
transmitting the anomaly data to a remote analysis module;
analyzing the anomaly data; and
identifying actionable recommendations for modifying the operation of the irrigation machine.

15. A method for use with the system of claim 4, wherein the method comprises:
detecting an anomaly;
developing a drone flight path based on the detected anomaly;
executing a drone flight along the drone flight path to collect anomaly data;
returning to the drone housing;
transmitting the anomaly data to a remote analysis module;
analyzing the anomaly data; and
identifying actionable recommendations for modifying the operation of the irrigation machine.

16. A method for use with the system of claim 5, wherein the method comprises:
detecting an anomaly;
developing a drone flight path based on the detected anomaly;
executing a drone flight along the drone flight path to collect anomaly data;
returning to the drone housing;
transmitting the anomaly data to a remote analysis module;
analyzing the anomaly data; and
identifying actionable recommendations for modifying the operation of the irrigation machine.
